(19) United States
(12) Patent Application Publication
(10) Pub. No.: US 2019/0232515 A1
(43) Pub. Date: Aug. 1, 2019

(54) Portable Scoring and Slicing Machine

(71) Applicant: Gunntech Manufacturing, Inc., Hayden, ID (US)

(72) Inventors: Nathaniel P. Brand, Coeur D'Alene, ID (US); Dalen E. Gunn, Coeur D'Alene, ID (US)

(73) Assignee: Gunntech Manufacturing, Inc., Hayden, ID (US)

(21) Appl. No.: 16/258,446

(22) Filed: Jan. 25, 2019

Related U.S. Application Data
(63) Continuation-in-part of application No. 62/622,340, filed on Jan. 26, 2018.

(51) Int. Cl. B26D 7/26; B26D 3/08; B26D 7/01

(52) U.S. Cl. CPC B26D 7/2635; B26D 7/015; B26D 3/085

(57) ABSTRACT

A highly portable, manually operated or power actuated, scoring and slicing apparatus for semi-rigid, fibrous, and/or resilient sheet and plank materials comprising a plurality of circular blades, each with a corresponding receiver and adjustment mechanism, a plurality of blade cartridges, removable guides, and latching mechanisms, drive wheels with drive lugs and corresponding lower blades, drive shafts and coupled gear trains, supported by a rigid frame constituting a plurality of rigid frame plates fastened to rigid spacers and pillow blocks, which in combination allow an operator to quickly adjust the present invention for making straight slices or score lines on materials of various widths and thicknesses, or with the removal of the guides, to make arbitrarily curved cuts on sheet or plank materials. The aforementioned device may further incorporate a storage compartment inside a structural frame with access via a hinged lid.

### CROSS-REFERENCE TO RELATED APPLICATIONS

This application is a continuation-in-part of an earlier, now pending, U.S. provisional application No. 62/622,340, filed Jan. 26, 2018, which describes and illustrates the apparatus of the instant application.

### FIELD OF THE INVENTION

The described, illustrated and claimed invention relates to the field of portable tools for scoring and slicing planar materials.

### BACKGROUND OF THE INVENTION

Scoring and slicing cutters are used in many industries to cut sheet materials. In particular, such cutters are used in several common applications to cut materials which are unsuitable for shearing or sawing due to their shape or structure or to reduce the formation of undesirable dust and/or shavings.

There are many examples of manually operated cutters utilizing a scoring action in the prior art. Some prior art in the same scope as the present invention includes the following: In U.S. Pat. No. 5,480,081, K. R. Wilson et. al. describe a manually operated score-and-snap apparatus of the common type for ceramic and porcelain tile and plank materials with a novel means of providing adjustable angles and positioning for the guides and measurement devices. Their device, like earlier work by S. I. Granite shown in U.S. Pat. No. 1,995,741, and by Wun-Hui Liu in U.S. Pat. No. 5,169,045, is suitable only for materials of a predetermined length, such as square or rectangular ceramic tiles. In U.S. Pat. No. 4,949,462 M. P. Spencer describes an apparatus for guiding a blade while cutting large panels of material manually, drywall in particular. His device provides no means of securing the guiding mechanism in close proximity to the material being cut, nor does it utilize a rolling, circular blade. Further, he does not describe quick-release clamps for securing the device after adjustment, nor a handle for applying motive force to his device. In U.S. Pat. No. 5,046,392 Keon et al. describe a cutter for insulation batt material which utilizes rotating cutting rollers mounted to a carriage which travels along a carriage rail. Their device is limited to cutting only the length of the carriage rail and cannot cut materials of arbitrary length. Further, they present as a cutting mechanism a pair of rotating rollers, which will invariably cut a fixed-width strip of material from the cut section, which is undesirable for some uses. In U.S. Pat. No. 7,082,688 E. J. Votolato shows a knife with built-in guides for cutting along pre-existing straight edges. His disclosure provides no means of adjusting the offset-distance from the straight edge. In U.S. Pat. No. 3,130,622 W. F. Eno and similarly in U.S. Pat. No. 3,779,119 Israel Broides, there is shown cutting devices which utilize a fixed blade mounted to a carriage, which travels on a track. Like Keon et al., the devices described by Eno and Broides can only make cuts up to the length of the track and are unsuitable for materials of arbitrary length. In U.S. Pat. No. 3,296,911 J. S. McLane describes a severing apparatus for cutting transversely sheets of material both longitudinally and. His apparatus is large and comprises a heavy frame to which the cutting components and guide members are mounted, rendering it not easily portable in spite of its manual operation. In U.S. Pat. No. 3,730,043A, E Zimmerman describes a device which uses a plurality of circular shearing blades of a particular geometry to cut thin webs into strips. His device does not provide means of guiding material, nor for propelling it, nor, indeed, for supporting it. U.S. Pat. No. 4,685,364A to Scheflow et. al. describes a rotary slicer for comestible products, particularly suited to slab, block, and loaf shaped materials. His invention describes an orbiting blade and a table which moves with the blade. Their device is unsuitable for cutting sheet and plank materials of arbitrary length. In U.S. Pat. No. 4,292,867A C. A. Stoffels and N. J. Genovese describe an apparatus and method for slitting elongated rolls of material. Their apparatus is exclusively suited to materials rolled upon a tubular core and unsuited for sheet and plank materials not rolled onto a tubular core.

The prior art does not teach a manually operated, highly portable device for longitudinally scoring and slicing sheet and plank materials of arbitrary length. Further, none of the self-contained and portable devices shown in the prior art provide means of securing guiding and cutting mechanisms in close proximity to the material being cut. Further, the prior art does not describe quick release clamps for securing guides or cutter carriages in place. Further, none of the prior art describes a pair of circular blades for slicing where they are quickly adjustable in both lateral and vertical directions. Further, none of the prior art describes a lower circular blade mounted to the side face of a drive roller. Further, none of the prior art provides a mechanism suitable for cutting an arbitrary curve in sheet and plank material. Further, none of the prior art describes a scoring and slicing tool with a frame constructed such that it comprises an integrated storage compartment.

### SUMMARY OF THE INVENTION

The present invention is a self-contained, portable, scoring and slicing apparatus for semi-rigid, fibrous, and/or resilient sheet and plank materials such as vinyl flooring, paper, cardboard, carpet, rubber sheet, or leather. The present invention may be optionally actuated manually, by a motor, or by another rotational prime mover. In particular, the present invention comprises a rigid frame, pillow blocks, one or more drive axles, one or more drive rollers, one or more idler rollers, one or more blade receivers with corresponding blade cartridges, two or more circular blades, a planar deck, and a removable guide fence. The rigid frame is constructed of a metal or composite material and is shaped like an elongated letter C to provide clearance for operation. The pillow blocks are rigidly fastened to the rigid frame and the drive axle(s) are pivotally engaged therewith. Each drive roller is engaged with a drive axle with a rotational locking mechanism such as a keyway, spline, or cotter pin. Each blade receiver is removably connected to the rigid frame with one or more snap-action mechanisms such as ball detents or toggle clamps. The blade cartridges comprise a housing, a plurality of blade alignment spacers, an axle, and a quick-release attachment mechanism such as a ball-detent catch. Each blade cartridge is secured to a blade receiver by a quickly adjustable mechanism, the mechanism causing or arresting translation of the blade cartridge normal to the surface of the material to be cut. Examples of quickly adjustable mechanisms suitable to secure the blade cartridge to the blade receiver include screw-follower pairs, rack-and-pinion apparatus with latching or ratcheting members, linear slides with cam latches, and detent-latching shafts. The planar deck is fastened to the rigid frame and is substantially orthogonal thereto. The invention further comprises a supporting structure fastened to the table and to the rigid frame. The supporting structure is made of plastic, aluminum, or other suitable material. The invention further comprises a track. The track is substantially prismatic in shape, the cross section being tee shaped, round, rectangular, or a more complex shape. The track is fastened to the supporting structure and the removable guide fence is secured to the track using a quick-release mechanism such as a cam or toggle. One or more drive rollers further comprise a second rotational locking mechanism such as a spline, keyway, or through-face fastener, and are each engaged with a circular blade with a larger diameter than the drive roller. It has been found that a circular blade with a diameter 2 mm larger than the drive roller provides excellent cut quality when cutting vinyl flooring material and when cutting paper or non-corrugated cardboard. The drive axle(s) are driven by a gear train, in turn driven by a handle crank or a prime mover such as an electric motor. In between the side panels of the rigid frame, the present invention comprises rigid spacers such that a storage area is formed. The present invention further comprises a lid which pivots to provide access to the storage compartment.

The present invention is operated by turning the drive shaft, either manually or through the use of a prime mover such as an electric motor, and feeding a sheet or plank of material between the blades. The drive roller(s) draw the material through the device and the guide fence optionally guides the material in a straight line. If the guide fence is removed, the operator may guide the material such that the resulting cut is curved or shaped, analogous to the operation of a vertical band saw. The operator may adjust the distance between the blades using the adjustment mechanism. The blades may be positioned such that they completely sever the material during operation, or such that they cut partial through, that is, score the material. If the operator scores the material, he will bend it after scoring to cause it to snap along the scored line.

### BRIEF DESCRIPTION OF THE DRAWING

Embodiments of the described apparatus are illustrated only as examples in the figures of the accompanying drawing sheets wherein the same reference numeral refers to the same element as it may appear in several drawing sheets described as follows:

FIG. 1 is a front elevation view of an embodiment of the described invention;

FIG. 2 is an enlarged view taken according to cutting plane line B in FIG. 1;

FIG. 3 is a left side elevation view taken according to cutting plane line A-A in FIG. 1.

FIG. 4 is an exploded perspective view of a bottom circular blade and drive rollers thereof;

FIG. 5 is a top plan view thereof;

FIG. 6 is a front elevation view taken according to cutting plane line C-C in FIG. 5;

FIG. 7 is a bottom plan view thereof;

FIG. 8 is a perspective view thereof showing top, front and right side thereof with a lid 39 closed; and

FIG. 9 is a view of FIG. 8 shown with lid 39 open.

### DETAILED DESCRIPTION OF THE INVENTION

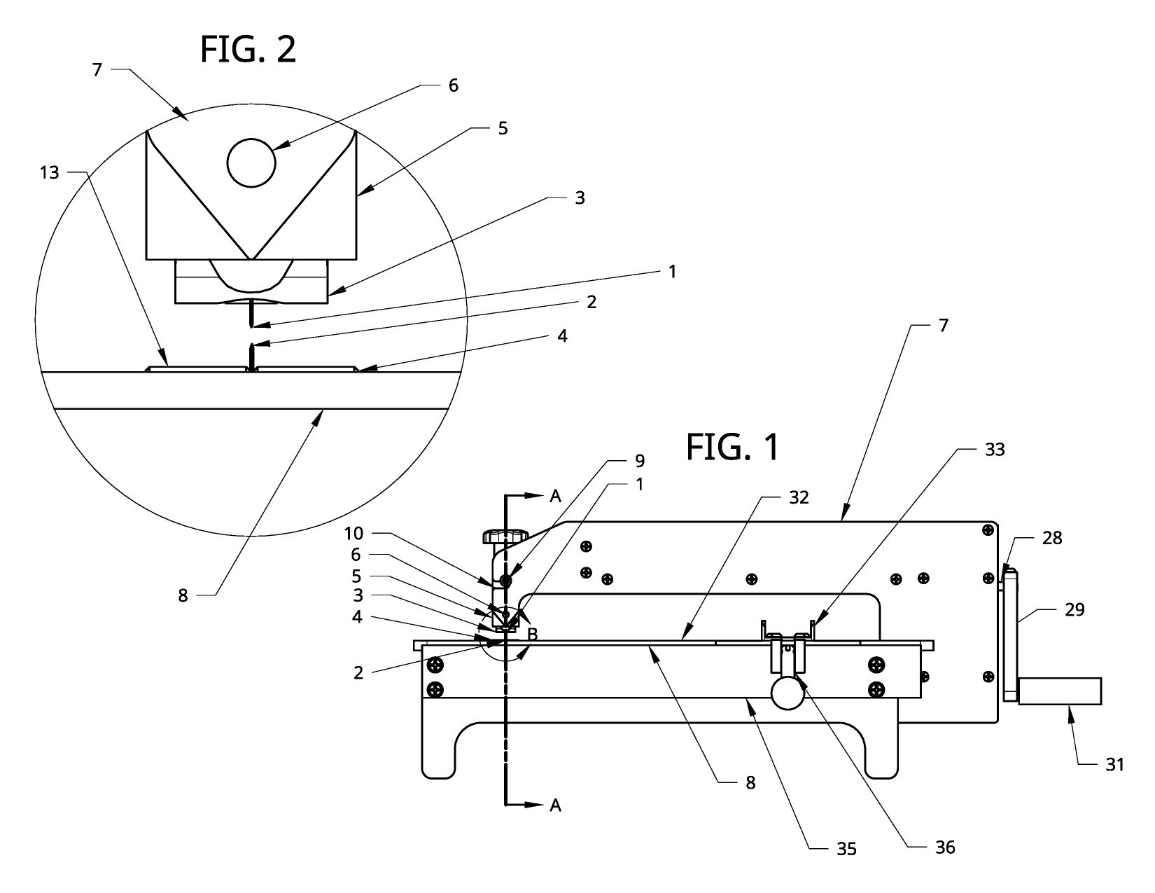

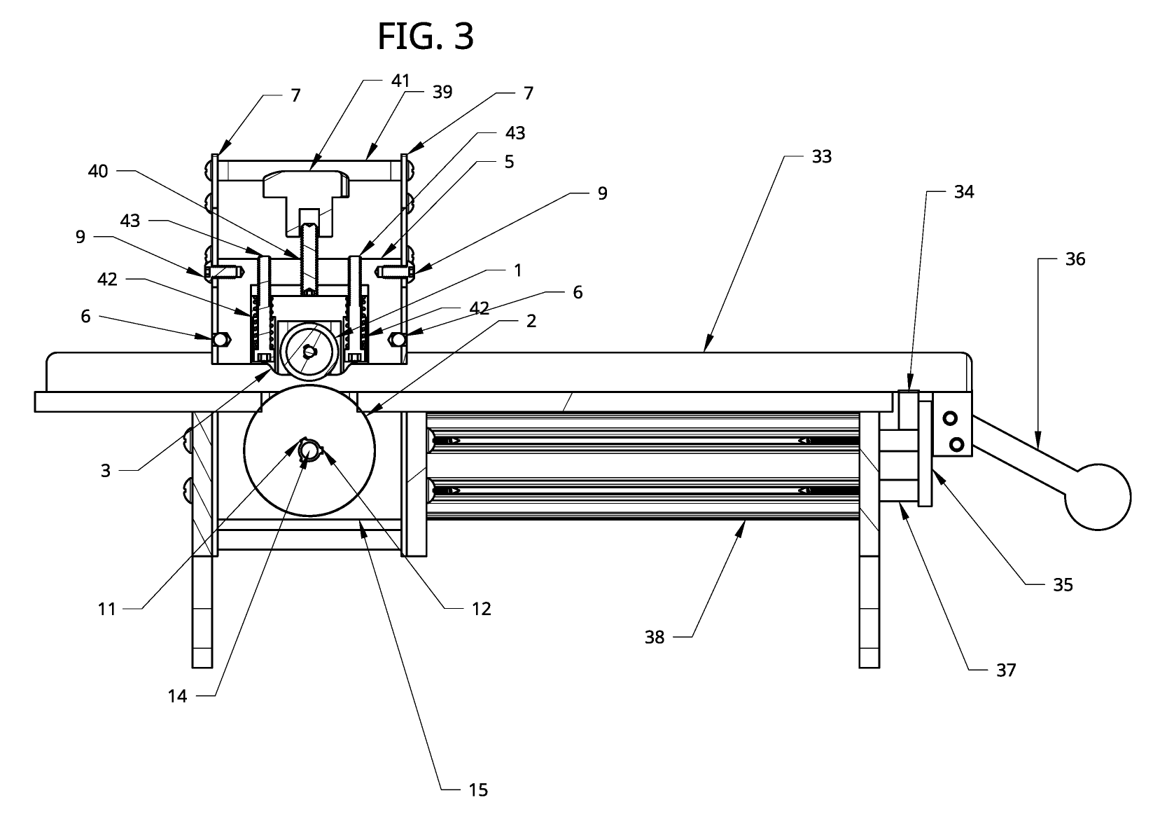

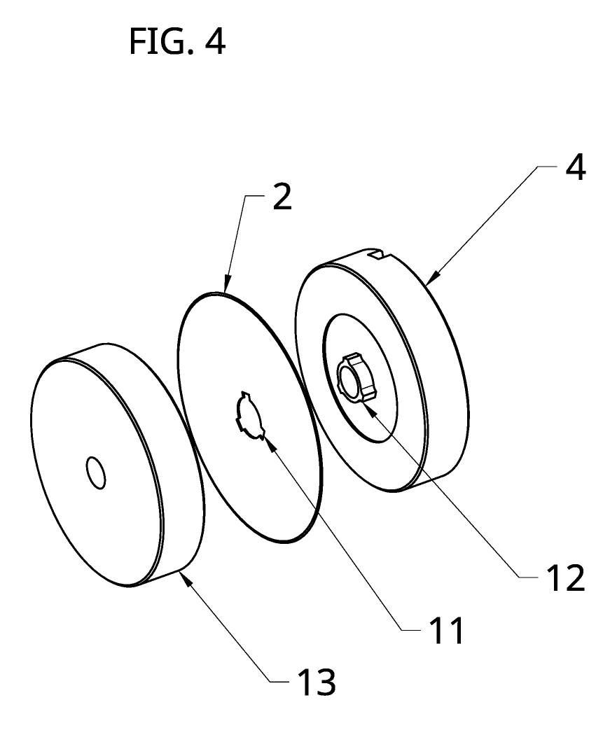

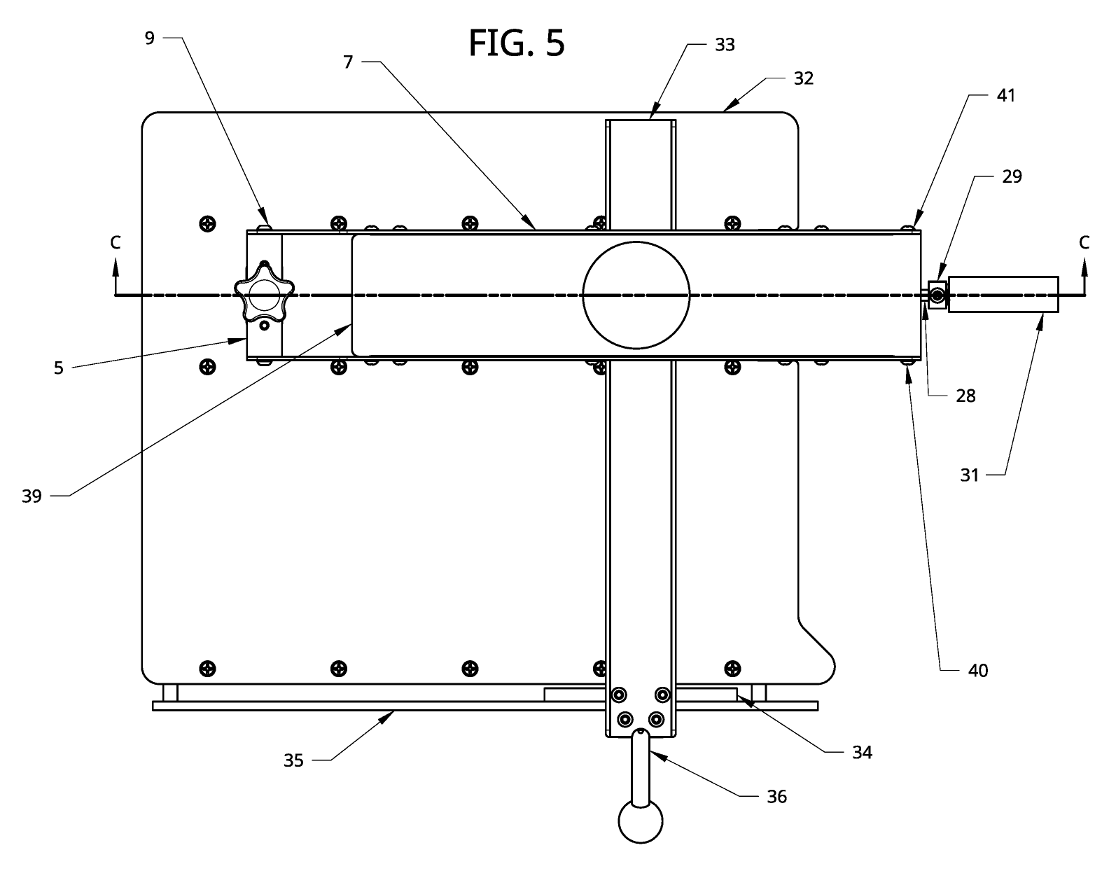

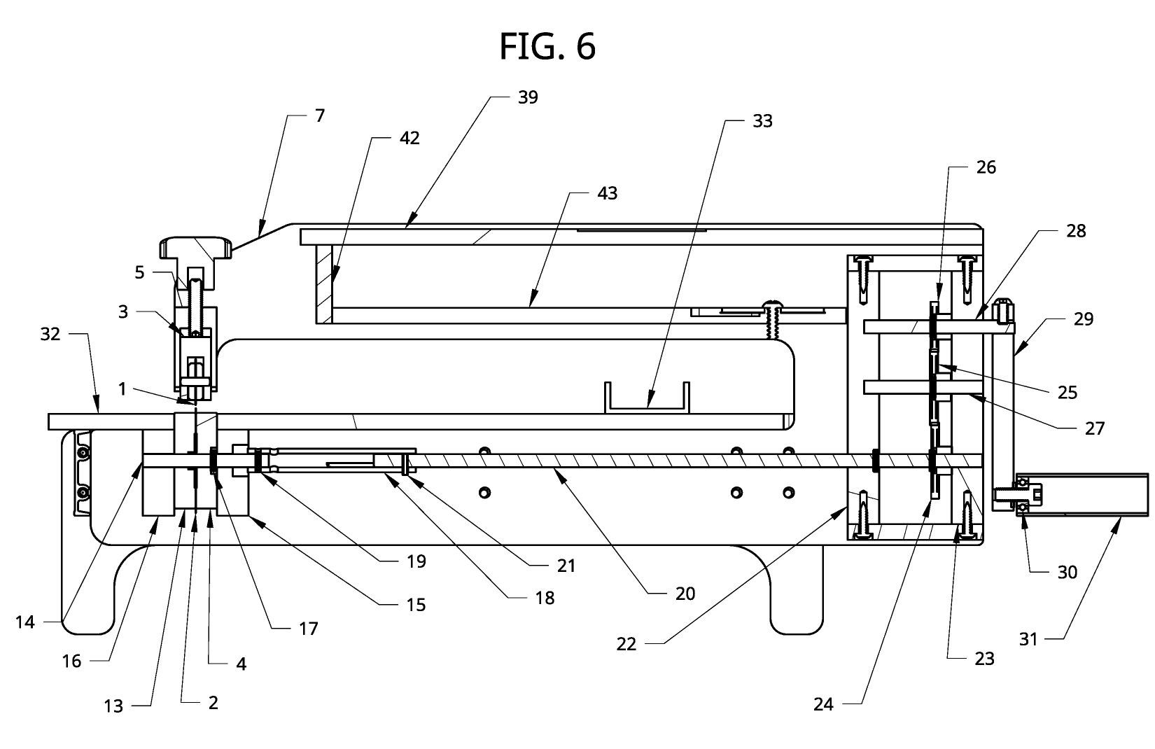

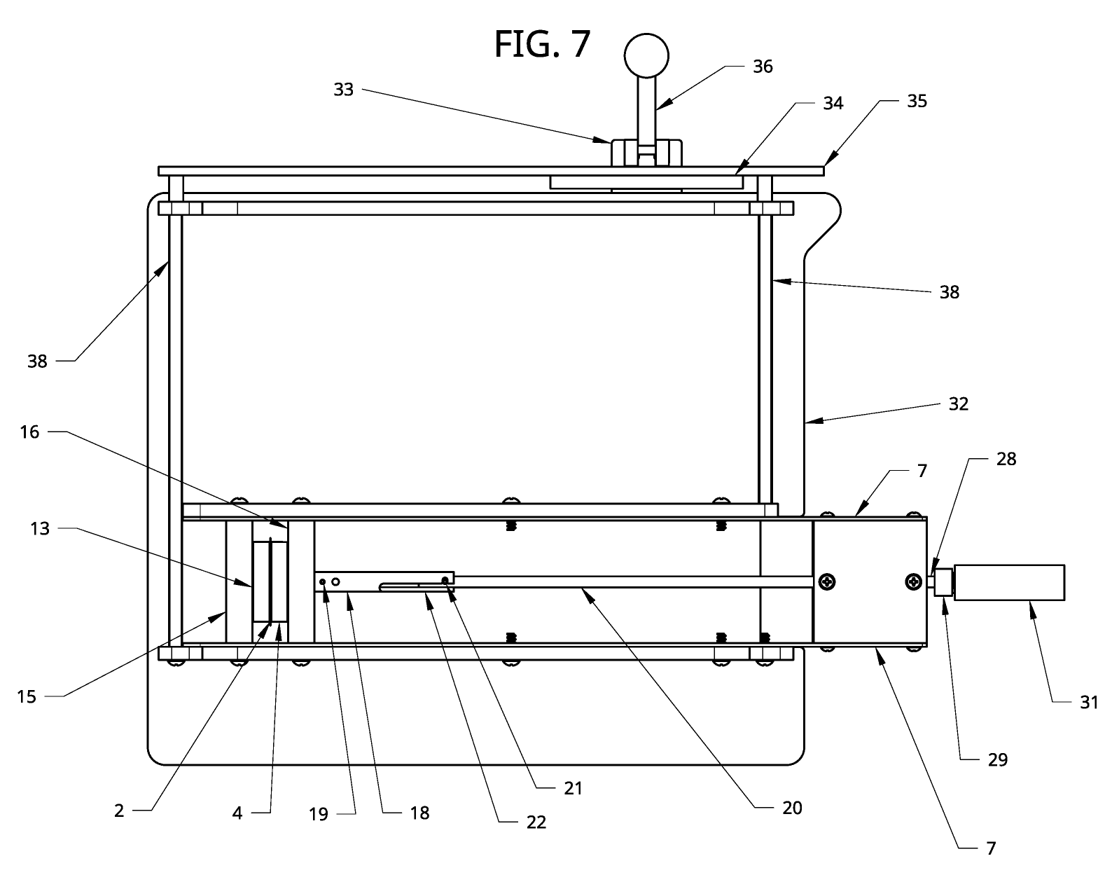

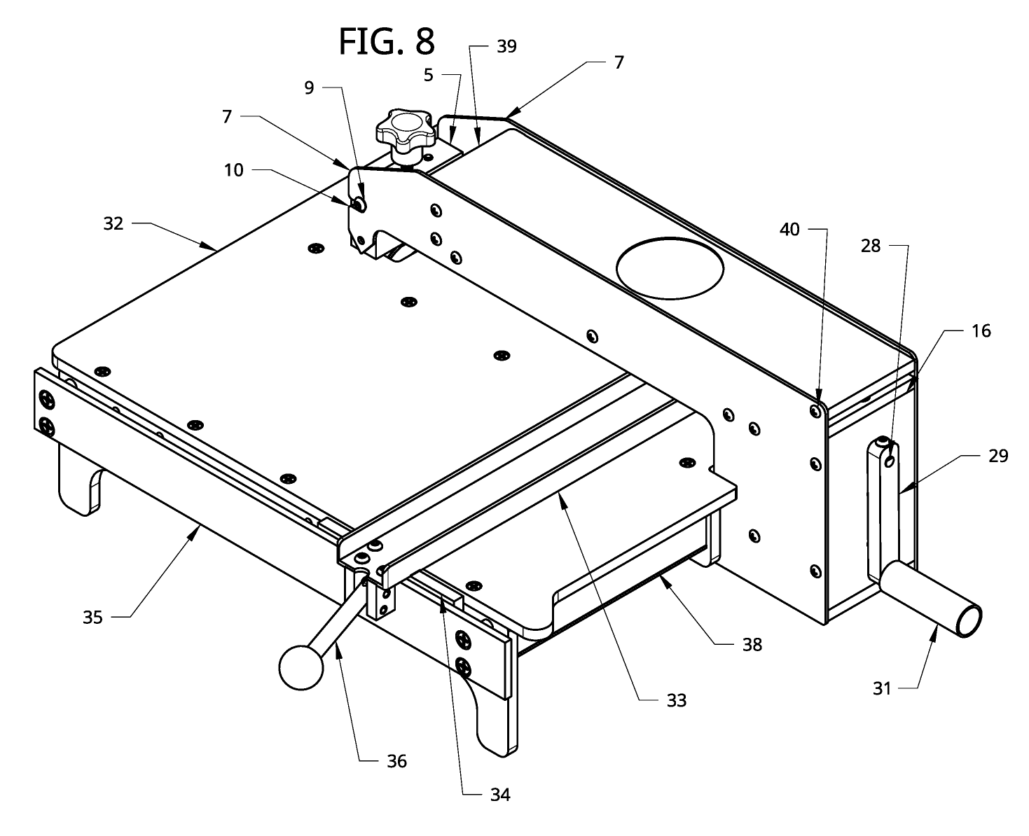

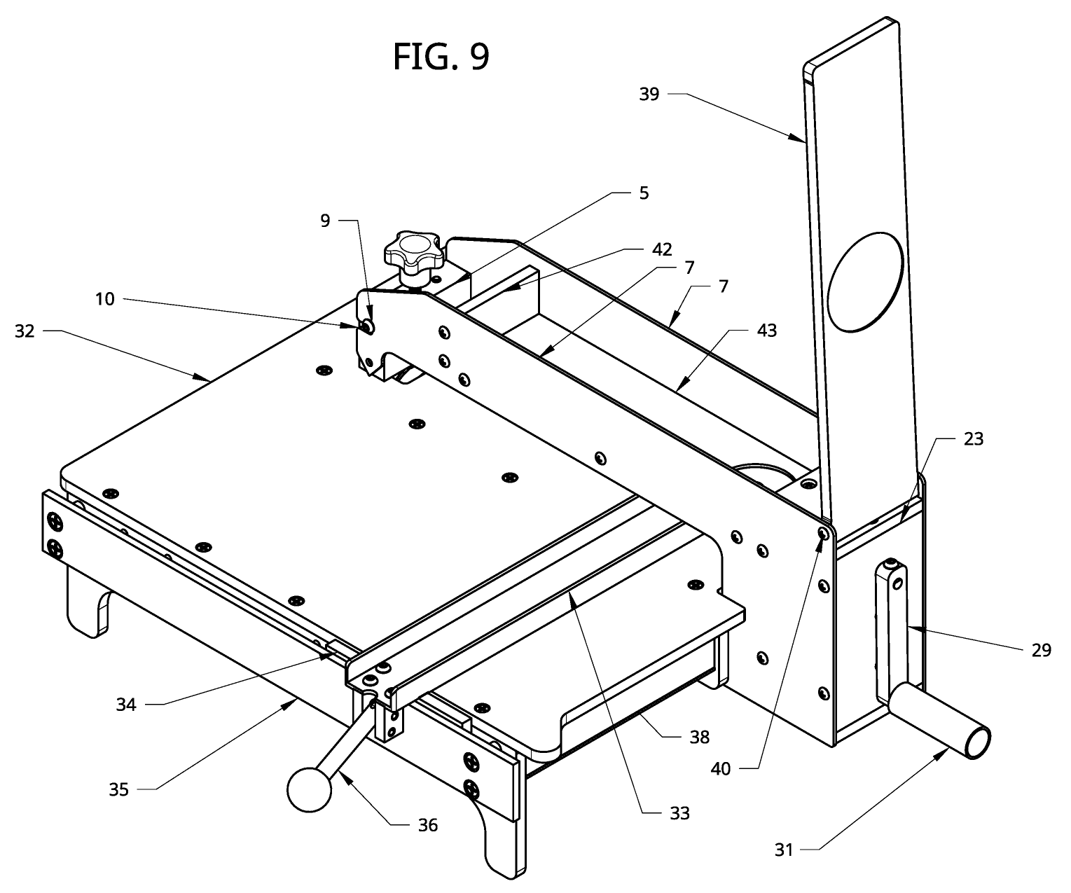

Referring now to the drawings in greater detail, in FIGS. 1-4 and FIG. 6, there is shown a top circular blade 1 and a bottom circular blade 2, both constructed from a hard material such as metal or ceramic. Now referring to FIGS. 2 and 3, the top circular blade 1 is mounting in an adjustable carriage 3, the mount allowing the circular blade 1 to rotate freely about its primary axis. The bottom circular blade 2 is mounted between a drive roller 4 and a follower roller 13. The top circular blade 1 and bottom blade 2 are positioned such that when the adjustable carriage 3 is moved downward the two blades will bypass one-another much like the shearing action commonly seen in scissors. The adjustable carriage 3 is translatably mounted in a receiver 5. Adjustment of the relative position of the adjustable carriage 3 and the receiver 5 is accomplished with the adjustment screw 40, which is turned by the knob 41. The adjustable carriage 3 is held in contact with the adjustment screw 40 by a plurality of springs 42, each held in place with a retaining stud 43. Now referring to FIG. 2 and FIG. 3, the receiver 5 is connected to rigid frame plates 7 with snap-action detents 6. Referring now to FIG. 1 and FIG. 3, the receiver 5 is further connected to the rigid frame plates 7 by studs 9, referring now to FIG. 1 and FIGS. 8-9, the studs 9 are captured in the alignment slots 10 of the rigid frame plates 7. Referring now to FIG. 3 and FIG. 4, the bottom blade 2 has a formed cutout 11 which interlocks with the shaped arbor 12 on the drive roller 4. The formed cutout 11 and shaped arbor 12 may have a simple circular cross-section with one or more locking keyways and keys, an angular geometric profile such as a triangle, rectangle, or hexagon, or a spline profile with one or more teeth. Referring now to FIGS. 6-7, there is shown a drive axle 14 onto which the drive roller 4 and follower roller 13 are seated. The drive axle 14 is supported by an inner pillow block 15, and an outer pillow block 16. The drive axle 14 is removably engaged with the drive roller 4 by key 17 and rigidly fastened to a quick-disconnect collar 18 by pin 19. The quick-disconnect collar 18 is slidingly engaged with the long drive shaft 20 and latched to locking lug 21, now referring to FIG. 7, by cam groove 22. Now referring to FIG. 6 and FIG. 7, the locking lug 21 is rigidly fastened to the long drive shaft 20. Referring again to FIG. 6, the long drive shaft 20 is supported by an inner tall pillow block 22 and an outer tall pillow block 23. The long drive shaft 20 is rigidly fastened to a gear 24, which is engaged with a second gear 25, which is in turn engaged with a third gear 26. The second gear 25 is rigidly fastened to a freely rotating axle 27 in turn supported by the inner pillow block 22 and the outer pillow block 23. The third gear 26 is rigidly fastened to the crankshaft 28, in turn supported by the inner pillow block 22 and the outer pillow block 23. The crankshaft 28 is rigidly fastened to a crank arm 29. Referring now to FIG. 1 and FIGS. 5-9, the present invention further comprises a crank handle 31, now referring to FIG. 6, rigidly connected to a bearing 30, again referring to FIG. 1 and FIGS. 5-9, which is in turn fastened to the crank arm 29. Now referring to FIG. 6, the gears 24, 25, and 26 are sized such that the equivalent gear ratio from the crank handle 31 to edge of the bottom circular blade 2 is between 4:1 and 8:1, this determined through experimentation to be the preferable range for manually cranked operation by a person of average ability. Note that if powered operation is desired, the crank arm 29 may be removed and the crankshaft 28 connected to the output shaft of a rotary prime mover. In the case of operation with a rotary prime mover such as an electric, hydraulic, or pneumatic motor, the sizes of the gears 24, 25, and 26 should be sized to turn the bottom circular blade 2 with an edge speed between 12 inches per second and 24 inches per second, this having been determined through experimentation to be a comfortable range for manual feeding of material to be cut by a person of average ability. In further detail, still referring to FIG. 6, the pillow blocks 15, 16, 22, and 23 are rigidly fastened to rigid frame plates 7. In further detail, now referring to FIGS. 1-4 and FIGS. 6-7, the suggested embodiment of the present invention further comprises a rigid table 32, rigidly fastened to the rigid frame plates 7 and oriented orthogonal to both the frame plates 7 and to the blades 1 and 2. The suggested embodiment of the present invention further comprises a movable guide fence 33, rigidly fastened to a right-angle guide 34. Now referring to FIGS. 1-4 and FIG. 6, the right angle guide 34 is removably secured to a track 35 by a quick-release clamp 36, the quick release clamp being suitably fastened to the movable guide fence 33. Referring now to FIG. 4 and FIG. 7, the track 35 is rigidly fastened to a plurality of spacers 37 and to a support frame 38. Now referring to FIG. 6, the suggested embodiment of the present invention further includes a lid 39 pivotally attached to the rigid frame plates 7 at points 40 and 41, allowing the lid 39 to be opened as shown in FIG. 9, or closed as seen in FIGS. 1-3 and 5-8. In further detail, referring now to FIG. 6 and FIG. 9, the present invention further comprises rigid spacers 42 and 43, which form a side and the bottom of a storage compartment between the frame plates 7, inner pillow block 22, and lid 39.

Advantages of the present invention include, without limitation, a means of severing semi-rigid, fibrous, and/or resilient sheet and plank materials with a highly portable tool. Further, the present invention provides a removable and quickly adjustable the guide to set the width at which the material will be scored or cut. Further, the present invention provides means of driving and guiding the material such that a straight score or slice is made in the aforementioned material without undue attention or skill by the operator. Further, in the case that the straight cut is not desired, the present invention provides a means for the operator to score or slice material along an arbitrarily curved path. Further, the present invention provides means for quickly adjusting the position of the cutting mechanism(s) to vary the scoring depth or to completely sever the material. Further, the present invention imposes no limit to the length of a cut performed and is suitable to make longitudinal cuts on materials of arbitrary length. Further, the present invention presents a method of incorporating a storage compartment into a frame composed of rigid frame plates and rigid spacer blocks. In a broad embodiment, the present invention is a highly portable, manually operated or power actuated, scoring and slicing apparatus for semi-rigid, fibrous, and/or resilient sheet and plank materials. In particular, the present invention comprises a plurality of circular blades, each with a corresponding receiver and adjustment mechanism, a plurality of blade cartridges, removable guides, and latching mechanisms, drive wheels with drive lugs and corresponding lower blades, drive shafts and coupled gear trains, which in combination allow the operator to quickly adjust the present invention for making straight slices or score lines on materials of various widths or thicknesses, and with the removal of the guides, to make manually guided arbitrarily curved cuts on sheet or plank materials. In addition, the present invention includes a storage compartment inside of the structural frame with access via a hinged lid. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiments, methods, and examples, but by all embodiments and methods within the scope and spirit of the invention.

What is claimed is:

1. A portable machine tool comprising:
a plurality of circular blades, each said circular blade having a receiver and an adjustment mechanism;
a rigid frame with a plurality of frame plates fastened to rigid spacers and pillow blocks enabling adjust for making straight slices and score lines;
a plurality of blade cartridges, each said blade cartridge having a removable guide, a latching mechanism and a drive wheel; wherein
said machine tool is adapted for cutting and scoring various widths and thicknesses of substrates including arbitrarily curved cuts on sheet and plank materials.
